(19) United States
(12) Patent Application Publication
(10) Pub. No.: US 2023/0392422 A1
(43) Pub. Date: Dec. 7, 2023

(54) PROCESS FOR SECURING A DOOR TO AN OPENING

(71) Applicant: Guy Clapp, Fort Worth, TX (US)

(72) Inventor: Guy Clapp, Fort Worth, TX (US)

(21) Appl. No.: 17/834,120

(22) Filed: Jun. 7, 2022

(51) Int. Cl. E05D 11/00; E05D 3/02

(52) U.S. Cl. CPC E05D 11/0018; E05D 3/02

(57) ABSTRACT

A process of securing a door to an opening, using a hinge, comprising at least one adjustable screw which can move to change the door's fit into a frame, securing the adjusted door while the door is open, using at least one irremovable screw on the hinge, such that the screw cannot be removed while the door is closed.

### FIELD OF THE INVENTION

The present invention relates to a process for securing a door to an opening, more specifically, to toolboxes and tool walls.

### BACKGROUND

Toolboxes are used in a variety of configurations and purposes. Some toolboxes are configured to maximize storage in a compact container. Other toolboxes are configured to store higher quantities of tools.

Storage mechanisms may be configured to be easily accessible for tools that are used often. However, easily accessible storage mechanisms lack security and significant restraining features that prevent tools from being stolen as well as becoming loose floating items in a tool enclosure.

### SUMMARY OF THE INVENTION

The present invention comprises a process to secure a toolbox door to the toolbox with a doorstop mechanism. The toolbox includes a surface, a first tool holding mechanism coupled to the surface, at least one door coupled to the toolbox using a hinge, and at least one door stop mechanism coupled to the toolbox. The hinge is coupled to the toolbox using at least one removable screw and at least one irremovable screw. The hinge is coupled to the door using at least one removable screw and at least one irremovable screw.

### BRIEF DESCRIPTION OF THE DRAWINGS

FIG. 1 is a front perspective of an embodiment of a toolbox;

FIG. 2 is a front perspective of a hinge;

FIG. 3 is a back perspective of a hinge; and

FIG. 4 is a back perspective of a hinge in the door.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and “comprising”, when used in this specification, specify the presence of stated features, steps, operations, elements, and components, but do not preclude the presence or addition of one or more other features, steps, operations, elements, components, or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exem-plification of the invention and is not intended to limit the invention to the specific embodiments illustrated by the figures or description below.

The present invention will now be described by refer-encing the appended figures representing preferred embodiments.

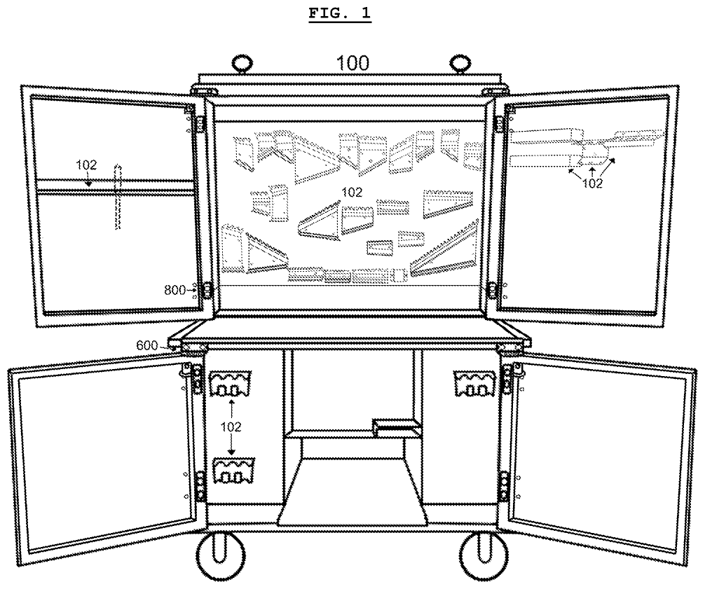

FIG. 1 depicts a front perspective of an embodiment of a toolbox 100. The toolbox 100 may comprise tool holding mechanism variants 102, at least one door, at least one door stop mechanism 600, and at least one hinge 700.

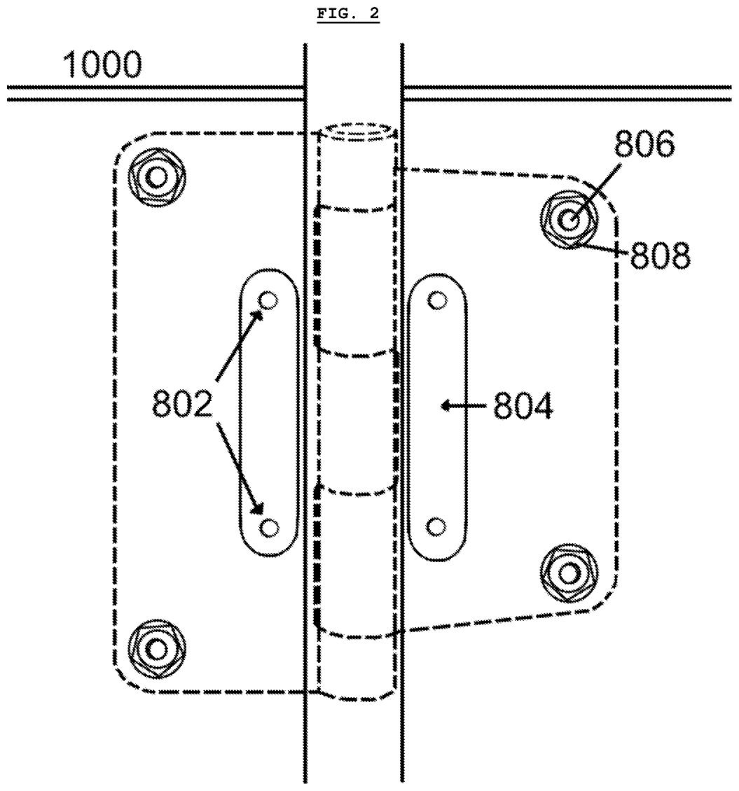

FIG. 2 depicts a front perspective of a hinge 700. In one embodiment, the hinge 700 may be the hinge featured in the hinge locking system 800 of FIG. 1. The hinge 700 may comprise a first side 702 coupled to a toolbox and a second side 704 coupled to a door of the toolbox. The first side 702 and second side 704 may be coupled to the toolbox and door, respectively, using a plurality of screw 706.

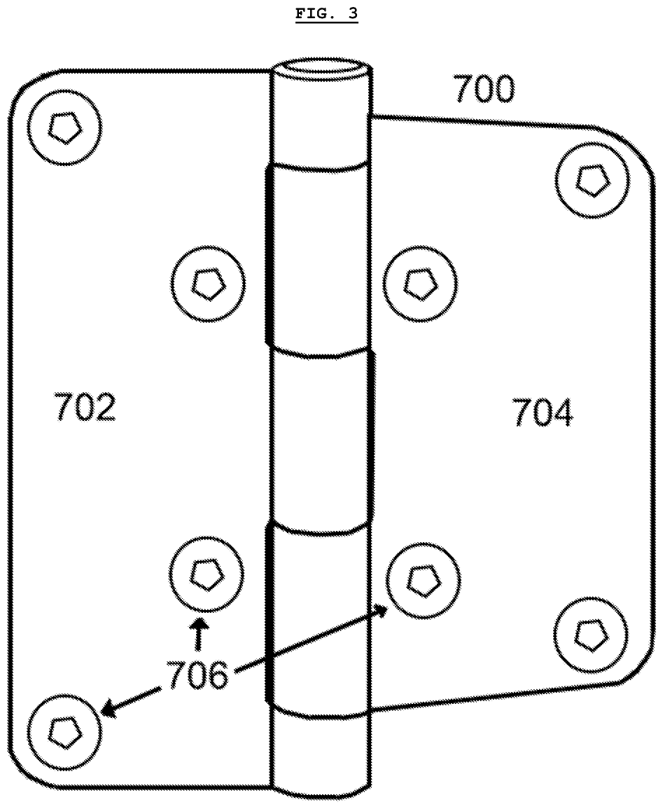

FIG. 3 depicts the hinge locking system 800 at a back perspective of a hinge 700. In one embodiment, the hinge locking system 800 may depict a back side of the second side 704 of the hinge 700 of FIG. 2. One of ordinary skill in the art will appreciate that a back side of the first side 702 of the hinge 700 of FIG. 2 may be substantially similar to the back side of the second side 704 of the hinge 700 of FIG. 2.

The hinge locking system 800 may comprise at least one first screw 802 captured by a secured surface 804 and at least one second screw 806 captured by a nut 808 on an opposite side of the toolbox and door, respectively. the secured surface being at least one of:

In one embodiment, the secured surface 804 may be the door or toolbox, respectively. In another embodiment, the secured surface 804 may comprise a material permanently coupled to the door or toolbox, respectively.

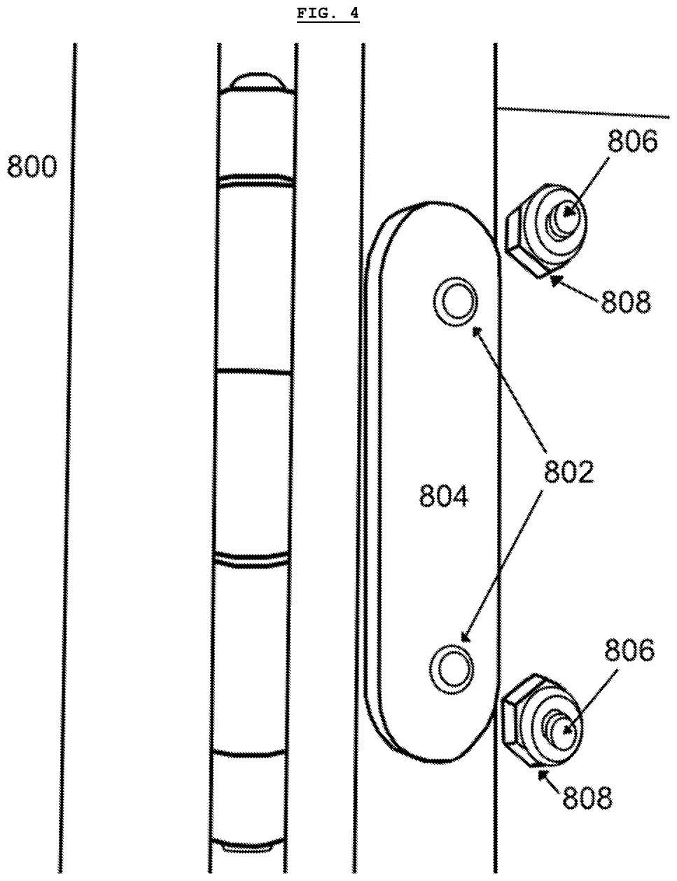

FIG. 4 depicts the hinge locking system 800 at a back perspective of a hinge 700 while including the hinge 700 outline. In one embodiment, the hinge locking system 800 may depict a back side of the second side 704 of the hinge 700 of FIG. 2. One of ordinary skill in the art will appreciate that a back side of the first side 702 of the hinge 700 of FIG. 2 may be substantially similar to the back side of the second side 704 of the hinge 700 of FIG. 2.

The hinge locking system 800 may comprise at least one first screw 802 captured by a secured surface 804 and at least one second screw 806 captured by a nut 808 on an opposite side of the toolbox and door, respectively. the secured surface being at least one of: In one embodiment, the secured surface 804 may be the door or toolbox, respectively. In another embodiment, the secured surface 804 may comprise a material permanently coupled to the door or toolbox, respectively.

In each embodiment, the hinge allows a user installing the door to an opening first using screws or bolts in such a way that the user can adjust the door's hinges. The user can repeatedly test the door's fit iteratively until the door is properly fitted to the frame. Once the user is satisfied that the door is properly fit to the frame, the user can use irremovable screws or locknuts to secure the door to the opening while the door is in an open position. This allows the door to be secure when it is closed as the hinges cannot be removed from the outside.

In one embodiment, a tool holding system may comprise a toolbox. The toolbox may comprise a surface, a first tool holding mechanism coupled to the surface, at least one door coupled to the toolbox using a hinge, and at least one door stop mechanism coupled to the toolbox. The hinge may be coupled to the toolbox using at least one removable screw and at least one irremovable screw. The hinge may be coupled to the door using at least one removable screw and at least one irremovable screw.

While this disclosure uses the phrase “irremovable screw”, the phrase includes any device that would serve the purpose of affixing the door to a hinge or hinge to a door frame, including a bolt and nut combination or any other means for such fixation.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments.

While the invention has been described with reference to exemplary embodiments, it will be understood by those skilled in the art that various changes may be made and equivalents may be substituted for elements thereof without departing from the scope of the invention.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention.

In the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

Moreover, the use of the terms first, second, etc. do not denote any order or importance, but rather the terms first, second, etc. are used to distinguish one element from another.

A legend of components discussed herein follows:
Toolbox 100
Tool Holding Mechanism Variants 102
Door Stop Mechanism 600
Hinge 700
First Side 702
Second Side 704
Screw 706
Hinge locking system 800
First Screw 802
Secured Surface 804
Second Screw 806
Nut 808

The inventor claims:

1. The process of securing a door to an opening, comprising:
a. Installing a door to an opening using a hinge, the hinge comprising at least one screw which is capable of movement to change the door's fit to a frame;
b. Adjusting the screw to fit the door to the desired position in relation to a frame;
c. Repeating the adjustment until the door properly fits the frame's opening; and
d. Securing the adjusted door while the door is open, using at least one irremovable screw on the hinge, such that the screw cannot be removed while the door is closed.
